(19) United States
(12) Patent Application Publication
(10) Pub. No.: US 2025/0355324 A1
(43) Pub. Date: Nov. 20, 2025

(54) IMAGE CAPTURE DEVICE AND LIGHT PATH SWITCHER

(71) Applicant: GUANGZHOU LUXVISIONS INNOVATION TECHNOLOGY LIMITED, Guangzhou City (CN)

(72) Inventor: Cheng-Te Tseng, Guangzhou City (CN)

(73) Assignee: GUANGZHOU LUXVISIONS INNOVATION TECHNOLOGY LIMITED, Guangzhou City (CN)

(21) Appl. No.: 19/193,703

(22) Filed: Apr. 29, 2025

Related U.S. Application Data
(60) Provisional application No. 63/647,768, filed on May 15, 2024.

(30) Foreign Application Priority Data
Aug. 23, 2024 (CN) 202411163629.8

(51) Int. Cl. G03B 9/08; G03B 17/17

(52) U.S. Cl. CPC G03B 9/08; G03B 17/17

(57) ABSTRACT

An image capture device includes a first lens assembly having a first optical axis, an optical steering element reflecting the first optical axis, a second lens assembly having a second optical axis parallel to the first optical axis, a light path switcher selectively allowing imaging light incident on the first lens assembly and the second lens assembly at an angle of incidence greater than or equal to a critical angle to pass, and an image sensor located downstream of the light path switcher to capture the imaging light, light path-wise. The light path switcher includes a first light-transmitting medium and a second light-transmitting medium. When incident on the second light-transmitting medium from the first light-transmitting medium, the imaging light is reflected at the light path switcher. When not incident on the second light-transmitting medium, the imaging light passes through the first light-transmitting medium to penetrate through the light path switcher.

### CROSS-REFERENCE TO RELATED APPLICATIONS

This non-provisional application claims the benefit of U.S. provisional application Ser. No. 63/647,768 filed on May 15, 2024 and claims the priority of patent application No. 202411163629.8 filed in China, P.R.C. on Aug. 23, 2024. The entire of the above-mentioned patent applications is hereby incorporated by references herein and made a part of the specification.

### BACKGROUND

### Technical Field

The present disclosure relates to an image capture device, and in particular, to an image capture device including a light path switcher.

### Related Art

In today's electronic devices for daily use, most of them are equipped with an image capture device for photography, and with the increasing demand of users for a photography function, many image capture devices each include multiple lenses, and different lenses are responsible for photography within different focal length ranges. The multiple lenses generally include macro lenses, wide-angle lenses, telephoto lenses, etc. to facilitate photography with different needs of.

### SUMMARY

In view of this, the present disclosure provides an image capture device, including a first lens assembly, an optical steering element, a second lens assembly, a light path switcher, and an image sensor. The first lens assembly has a first optical axis. The optical steering element is adjacent to the first lens assembly and includes a reflecting surface, and the first optical axis is reflected at the reflecting surface. The second lens assembly is adjacent to the first lens assembly and has a second optical axis parallel to the first optical axis. The light path switcher is located downstream of the reflecting surface and the second lens assembly in relation to a light path, is configured to selectively allow or not allow imaging light entering from the first lens assembly and the second lens assembly to pass, and includes a first light-transmitting medium and a second light-transmitting medium. The imaging light is incident on the first light-transmitting medium at an angle of incidence, the angle of incidence is greater than or equal to a critical angle, the first light-transmitting medium includes a first side and a second side opposite to each other, and the first side has a first refractive index. The second light-transmitting medium has a second refractive index, and the second refractive index is less than the first refractive index. In response to that the second light-transmitting medium is located between the first side and the second side, the light path switcher is configured to allow the imaging light incident on the first light-transmitting medium to be reflected at the first light-transmitting medium. In response to that the second light-transmitting medium is not located between the first side and the second side, the light path switcher is configured to allow the imaging light incident on the first light-transmitting medium to pass through the first light-transmitting medium. The image sensor is located downstream of the light path switcher in relation to a light path and configured to capture the imaging light.

In one embodiment, the second side of the first light-transmitting medium is a first lens, the first side of the first light-transmitting medium is a light-transmitting component, the light-transmitting component has a surface, and the light-transmitting component is attached or not attached to the first lens with the surface.

In one embodiment, the light path switcher includes an accommodating space, the accommodating space is communicated between the first side and the second side of the first light-transmitting medium, and in response to that the light-transmitting component is attached to the first lens with the surface, the second light-transmitting medium is accommodated in the accommodating space.

In one embodiment, the light-transmitting component includes a membrane and a first light-transmitting fluid, the membrane forms a chamber, the first light-transmitting fluid is accommodated in the chamber, and the surface is the side of the membrane oriented towards the first lens.

In one embodiment, the light-transmitting component further includes a frame and a second lens, the frame has a first end and a second end, the first lens is located at the first end of the frame, and the second lens closes the second end of the frame to form the chamber with the membrane.

In one embodiment, the light path switcher further includes a driving module, configured to drive the first light-transmitting fluid to flow so as to deform the membrane so that the membrane is attached to the first lens.

In one embodiment, the driving module drives the first light-transmitting fluid to flow so as to deform the membrane so that the membrane is separated from the first lens.

In one embodiment, the light path switcher further includes a driving module and an actuator, the surface includes an outer side and an attaching portion located in the outer side, and the driving module is configured to drive the actuator to abut against the outer side to so as to make the first light-transmitting fluid flow to deform the attaching portion so that the attaching portion is attached to the first lens.

In one embodiment, the driving module is configured to generate a voltage to drive the actuator to abut against the membrane.

In one embodiment, the actuator is magnetic, and the driving module generates a magnetic force to make the actuator abut against the membrane.

In one embodiment, the light path switcher further includes a driving module and an actuator, the surface includes an outer side and an attaching portion located in the outer side, and the driving module is configured to drive the actuator to abut against the outer side so as to make the outer side shift in a direction away from the first lens, so that the attaching portion shifts in a direction towards the first lens to be attached to the first lens.

In one embodiment, the light path switcher further includes a driving module, and the driving module is configured to drive the light-transmitting component to shift towards the first lens, so that the light-transmitting component is attached to the first lens.

In one embodiment, the light path switcher includes a storage space and a second light-transmitting fluid, the storage space is communicated between the first side and the second side of the first light-transmitting medium, in response to that the second light-transmitting medium is located between the first side and the second side, the second light-transmitting fluid is accommodated in the storage space, and in response to that the second light-transmitting medium is not located between the first side and the second side, the second light-transmitting fluid is configured to shift from the storage space to a position between the first side and the second side.

In one embodiment, the second light-transmitting fluid has a third refractive index, and the third refractive index is greater than or equal to the first refractive index.

In one embodiment, the second light-transmitting medium is air, and the refractive index of the first light-transmitting medium is greater than the refractive index of the air.

In one embodiment, the optical steering element further includes an incident surface and an exit surface, and the first optical axis is incident from the incident surface, and exits from the exit surface after being reflected at the reflecting surface.

In one embodiment, the first lens assembly includes a first switch, and the second lens assembly includes a second switch; in response to that the first side and the second side of the first light-transmitting medium of the light path switcher are attached to each other, the first switch is configured to be turned on to allow the imaging light to pass, and in response to that the first side and the second side of the first light-transmitting medium of the light path switcher are not attached to each other, the second switch is configured to be turned on to allow the imaging light to pass.

In one embodiment, the first lens assembly includes a first lens group, the first lens group is located between the optical steering element and the first switch, and the second lens assembly includes a second lens group adjacent to the second switch.

In one embodiment, the image sensor has a sensing optical axis, and the sensing optical axis is aligned with the first optical axis of the first lens assembly reflected at the reflecting surface and is aligned with the second optical axis reflected at the light path switcher in response to that the first side and the second side of the first light-transmitting medium are not attached to each other.

In one embodiment, a focusing module is further included, the focusing module includes a focusing lens assembly and an actuating device, the focusing module is located between the light path switcher and the image sensor, and the actuating device is configured to actuate the focusing lens assembly to shift along the sensing optical axis.

In one embodiment, a stabilization module is further included, the hand vibration prevention module is electrically connected to the image sensor, and the stabilization module is configured to drive the image sensor to generate corresponding movement to offset hand tremor.

In one embodiment, the first lens assembly and the second lens assembly each have a focal length, and the first lens assembly and the focal lengths of the second lens assembly are different.

In one embodiment, the number of the second lens assemblies is greater than one, the number of the light path switchers is greater than one, all of the second lens assemblies are adjacent to each other, and all of the light path switchers are each located downstream of one of the second lens assemblies and the reflecting surface of the optical steering element in relation to a light path.

In one embodiment, a light-transmitting component is further included, and the light-transmitting component is located between the first lens assembly and the second lens assembly.

In one embodiment, a light-transmitting component is further included, and the light-transmitting component is located between each of the second lens assemblies.

The present disclosure further provides a light path switcher.

### BRIEF DESCRIPTION OF THE DRAWINGS

FIG. 1 is a 3D schematic view of an image capture device according to an embodiment;

FIG. 2 is a sectional view of a position marked 2-2 in the embodiment of FIG. 1;

FIG. 3 is a schematic diagram of a light path of imaging light entering an image capture device according to an embodiment;

FIG. 4 is a schematic diagram of a light path of imaging light entering an image capture device according to another embodiment;

FIG. 5 is a sectional view of a light path switcher according to an embodiment, showing that a first side and a second side are not attached to each other;

FIG. 6 is a sectional view of a light path switcher according to an embodiment, showing that a first side and a second side are attached to each other;

FIG. 7 is a schematic diagram of imaging light incident on an optically thinner medium from an optically denser medium to according to an embodiment;

FIG. 8 is a 3D exploded view of a light path switcher according to another embodiment;

FIG. 9 is a sectional view of a light path switcher according to the embodiment of FIG. 8, showing that a first side and a second side are not attached to each other;

FIG. 10 is a sectional view of a light path switcher according to the embodiment of FIG. 8, showing that a first side and a second side are attached to each other;

FIG. 11 is a schematic diagram of a light path switcher according to yet another embodiment;

FIG. 12 is a sectional view of a light path switcher according to an embodiment, showing that a second light-transmitting medium is located between a first side and a second side;

FIG. 13 is a sectional view of a light path switcher according to an embodiment, showing that a second light-transmitting medium is not located between a first side and a second side; and

FIG. 14 is a sectional view of an image capture device according to yet another embodiment.

### DETAILED DESCRIPTION

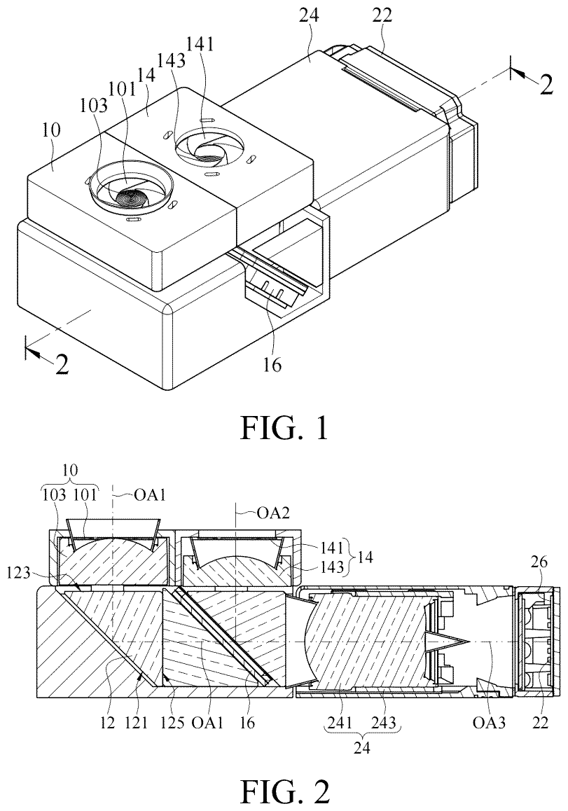

Refer to FIG. 1 and FIG. 2. FIG. 1 is a 3D schematic view of an image capture device according to an embodiment, and FIG. 2 is a sectional view of a position marked 2-2 in the embodiment of FIG. 1. The image capture device includes a first lens assembly 10, an optical steering element 12, a second lens assembly 14, a light path switcher 16, and an image sensor 22. The first lens assembly 10 has a first optical axis OA1. The optical steering element 12 is adjacent to the first lens assembly 10 and includes a reflecting surface 121. The first optical axis OA1 of the first lens assembly 10 is reflected at the reflecting surface 121. The second lens assembly 14 is adjacent to the first lens assembly 10. The second lens assembly 14 has a second optical axis OA2. The second optical axis OA2 is parallel to the part of the first optical axis OA1 that is not reflected at the reflecting surface 121 of the optical steering element 12.

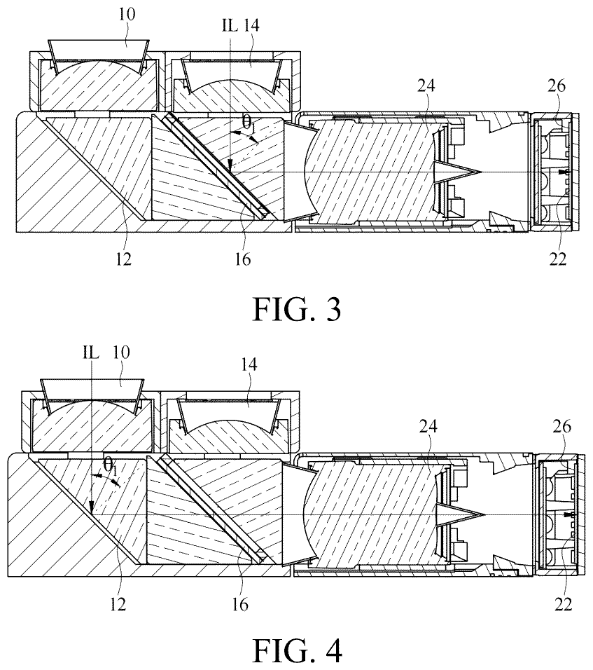

The light path switcher 16 is located downstream of the reflecting surface 121 and the second lens assembly 14 along the first optical axis OA1 and the second optical axis OA2 in relation to the light path. Refer to FIG. 3 and FIG. 4. FIG. 3 is a schematic diagram of a light path of imaging light entering an image capture device according to an embodiment, and FIG. 4 is a schematic diagram of a light path of imaging light entering an image capture device according to another embodiment. In some embodiments, imaging light IL of an object or scene to be shot by the image capture device enters the image capture device via the first lens assembly 10 or the second lens assembly 14. The imaging light IL entering the image capture device from the second lens assembly 14 will arrive at the light path switcher 16, while the imaging light IL entering the image capture device from the first lens assembly 10 will arrive at the light path switcher 16 after being reflected at the reflecting surface 121 of the optical steering element 12.

The light path switcher 16 may selectively allow or not allow the imaging light IL entering from the first lens assembly 10 and from the second lens assembly 14 to pass. The image sensor 22 is located downstream of the light path switcher 16. In response to that the light path switcher 16 allows the imaging light IL to pass, the imaging light IL entering from the first lens assembly 10 passes through the light path switcher 16 and arrive at the image sensor 22. In response to that the light path switcher 16 does not allow the imaging light IL to pass, the imaging light IL entering from the second lens assembly 14 is reflected at the light path switcher 16 to arrive at the image sensor 22. The image sensor 22 may form an image of the object or scene to be shot after capturing the imaging light IL.

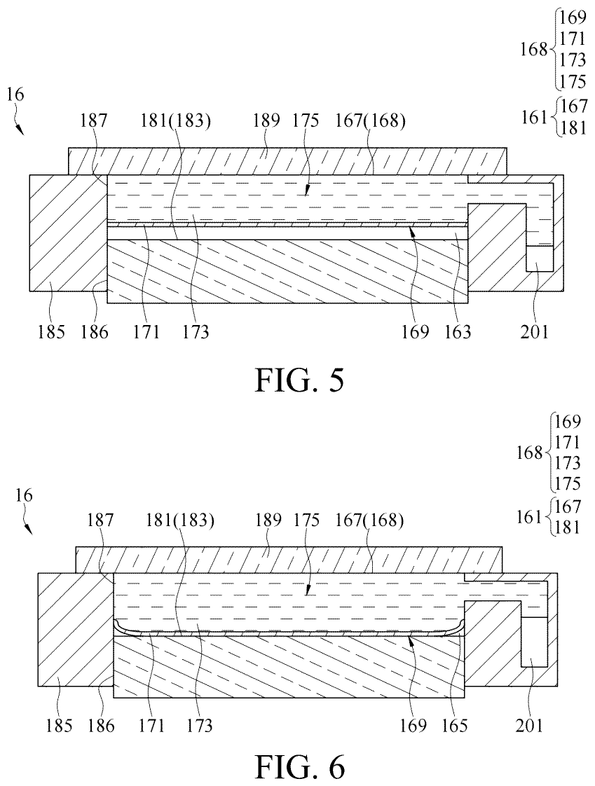

Refer to FIG. 5 and FIG. 6. FIG. 5 is a sectional view of a light path switcher according to an embodiment, showing that a first side and a second side are not attached to each other, and FIG. 6 is a sectional view of a light path switcher according to an embodiment, showing that a first side and a second side are attached to each other. The light path switcher 16 includes a first light-transmitting medium 161 and a second light-transmitting medium 163. The first light-transmitting medium 161 includes a first side 167 and a second side 181 opposite to each other. When incident on the light path switcher 16, the imaging light IL is incident on the first side 167 or the second side 181 of the first light-transmitting medium 161 at an angle of incidence. The angle of incidence of the imaging light IL is greater than or equal to a critical angle.

The first side 167 of the first light-transmitting medium 161 has a first refractive index. The second light-transmitting medium 163 has a second refractive index. The second refractive index is less than the first refractive index. In some embodiments, the light path switcher 16 includes an accommodating space 165. The accommodating space 165 is communicated between the first side 167 and the second side 181 of the first light-transmitting medium 161. The accommodating space 165 may be used for accommodating the second light-transmitting medium 163.

The first side 167 and the second side 181 of the first light-transmitting medium 161 may or may not be attached to control the imaging light IL to pass through the light path switcher 16 or be reflected at the light path switcher 16. In response to that the first side 167 and the second side 181 of the first light-transmitting medium 161 are not attached (as shown in FIG. 5), the second light-transmitting medium 163 is located between the first side 167 and the second side 181. At this time, the imaging light IL that enters the image capture device from the first lens assembly 10 or the second lens assembly 14 and is incident on the first light-transmitting medium 161 does not pass through the light path switcher 16 and is reflected at the first light-transmitting medium 161.

However, in response to that the first side 167 and the second side 181 of the first light-transmitting medium 161 are attached (as shown in FIG. 6), the second light-transmitting medium 163 is accommodated in the accommodating space 165. At this time, the imaging light IL that enters the image capture device from the first lens assembly 10 or the second lens assembly 14 and is incident on the first light-transmitting medium 161 passes through the light path switcher 16.

Further, whether the imaging light IL may pass through the light path switcher 16 has to do with whether the imaging light IL is incident on the second light-transmitting medium 163 with the second refractive index from the first side 167 with the first refractive index when the imaging light IL is incident on the first side 167 with an angle of incidence greater than or equal to the critical angle and then exits from the first side 167. In response to that the first side 167 and the second side 181 are not attached to each other, the second light-transmitting medium 163 is located between the first side 167 and the second side 181, and the imaging light IL is incident on the second light-transmitting medium 163 with the second refractive index from the first side 167 with the first refractive index. At this time, the first side 167 of the first light-transmitting medium 161 with the larger refractive index is taken as an optically denser medium, and the second light-transmitting medium 163 with the smaller refractive index is taken as an optically thinner medium, so that the imaging light IL is incident on the optically thinner medium from the optically denser medium.

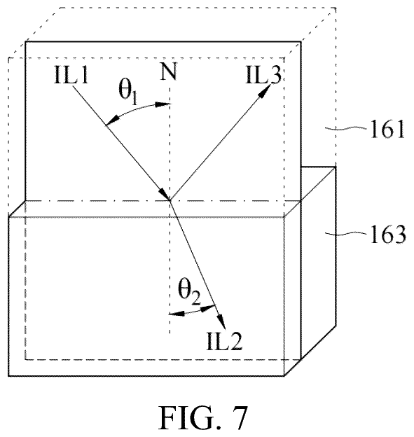

In response to that the imaging light IL is incident on the optically thinner medium from the optically denser medium at an angle of incidence greater than or equal to the critical angle, the imaging light IL is totally reflected at the optically denser medium. Specifically, refer to FIG. 7. The imaging light IL incident on the first light-transmitting medium 161 is incident light IL1. Generally, in response to that the incident light IL1 is incident on the second light-transmitting medium 163 with a refractive index less than that of the first light-transmitting medium 161 from the first light-transmitting medium 161, refracted light IL2 is generated. At this time, the relationship between the incident light IL1 and the refracted light IL2 satisfies: n₁ sin θ₁=n₂ sin θ², where n₁ and n₂ are the first refractive index and the second refractive index, respectively, θ₁ is an included angle between the incident light IL1 and an interface normal N (i.e., an angle of incidence θ₁), and θ₂ is an included angle between the refracted light IL2 and the interface normal N (i.e., an angle of refraction θ₂).

In response to that the incident light IL1 incident on the second light-transmitting medium 163 is incident at an angle of incidence θ₁ equal to a certain angle, the angle of refraction θ₂ is 90°. At this time, sin θ₂=1, and

$$sin {θ}_{1} = \frac{{n}_{2}}{{n}_{1}}$$

may be derived. Ine angle at which such incident light IL1 is incident is the critical angle θ_{c}. In response to that the angle of incidence θ₁ is greater than the critical angle θ_{c},

$$sin {θ}_{c} = sin {θ}_{1} > \frac{{n}_{2}}{{n}_{1}}$$

is derived, and then sin θ₂>1 is derived. However, sin θ₂>1 is physically meaningless. Therefore, in response to that the incident light IL1 is incident on the second light-transmitting medium 163 at an angle where the angle of incidence θ₁ is greater than the critical angle θ_{c}, there is no refracted light IL2 in the second light-transmitting medium 163. Instead, there is reflected light IL3 in the first light-transmitting medium 161 upon total reflection.

The value of the critical angle θ_{c} depends on the ratio of the first refractive index n₁ of the first light-transmitting medium 161 to the second refractive index n₂ of the second light-transmitting medium 163. I.e.,

$${θ}_{c} = {sin}^{- 1} ( \frac{{n}_{2}}{{n}_{1}} ) .$$

Refer to FIG. 3 and FIG. 5 again. Based on this, in response to that the first side 167 and the second side 181 of the first light-transmitting medium 161 are not attached to each other, the imaging light IL with an angle of incidence greater than or equal to the critical angle is incident on the second light-transmitting medium 163 as an optically thinner medium located between the first side 167 and the second side 181 from the first side 167 of the first light-transmitting medium 161 as an optically denser medium, and therefore the light is reflected at the first side 167.

Refer to FIG. 6 again. In some embodiments, the second side 181 of the first light-transmitting medium 161 has a third refractive index, and the third refractive index may be equal to or close to the first refractive index and greater than the second refractive index, so that in response to that the first side 167 and the second side 181 of the first light-transmitting medium 161 are attached to each other, the imaging light IL may directly pass through the second side 181 from the first side 167 and then pass through the light path switcher 16.

The first side 167 and the second side 181 may be made of the same or different materials, but the closer the third refractive index is to the first refractive index, the smaller the light offset will be after the imaging light IL is incident on the second side 181 (that is, the refraction will be less), and the image quality generated after the image sensor 22 receives the imaging light IL may be better.

For example, the first side 167 of the first light-transmitting medium 161 may be a liquid with a first refractive index of 1.4, the second side 181 may be glass with a third refractive index of 1.5, and the second light-transmitting medium 163 may be air with a refractive index of 1. Thus, in response to that the first side 167 and the second side 181 are not attached to each other, the imaging light IL is incident on the second light-transmitting medium 163 from the first side 167, which is the above-mentioned scenario where the imaging light IL is incident on the optically thinner medium from the optically denser medium, and then the imaging light IL is reflected at the first side 167. In response to that the first side 167 and the second side 181 are attached to each other, the imaging light IL is incident on the second side 181 from the first side 167, the refractive indexes of the first side 167 and the second side 181 are close to each other, and the imaging light IL may penetrate through the second side 181 from the first side 167.

In this example, since a numerical difference still exists between the first refractive index of the first side 167 and the third refractive index of the second side 181, in response to that the imaging light IL is incident on the second side 181, it is refracted at the second side 181. At this time, in the process of integrating the light path switcher 16 into the image capture device, the positions of the first lens assembly 10 and the second lens assembly 14 may be adjusted through optical active alignment to compensate for refraction offset generated when the imaging light IL passes through the light path switcher 16.

In response to that the first side 167 and the second side 181 are attached to each other, the second light-transmitting medium 163 originally located between a membrane 171 and a first lens 183 is accommodated in the accommodating space 165. In some embodiments, the second light-transmitting medium 163 may be a gas or a fluid with a refractive index less than those of the first side 167 and the second side 181 of the first light-transmitting medium 161. In response to that the second light-transmitting medium 163 is a fluid, the accommodating space 165 may be a container connected between the first side 167 and the second side 181. In response to that the second light-transmitting medium 163 is a gas (e.g., general air), the accommodating space 165 may be an atmospheric environment or a container.

Refer to FIG. 2, FIG. 5, and FIG. 6 again. In some embodiments, the first side 167 of the first light-transmitting medium 161 may be oriented towards the reflecting surface 121 of the optical steering element 12, while the second side 181 may be oriented towards the second lens assembly 14. Alternatively, the first side 167 of the first light-transmitting medium 161 may be oriented towards the second lens assembly 14, while the second side 181 may be oriented towards the reflecting surface 121 of the optical steering element 12, which is not limited here.

Refer to FIG. 5 and FIG. 6 again. In some embodiments, the first side 167 of the first light-transmitting medium 161 may be a light-transmitting component 168, and the second side 181 may be the first lens 183. The light-transmitting component 168 has a surface 169, and in response to that the first side 167 and the second side 181 are attached to each other, the surface 169 of the light-transmitting component 168 is attached to the first lens 183.

In some embodiments, the light-transmitting component 168 includes the membrane 171, and the surface 169 is the side of the membrane 171 oriented towards the first lens 183. The membrane 171 may form a closed chamber 173, and a first light-transmitting fluid 175 may be accommodated in the chamber 173. The membrane 171 may be elastic, and the light-transmitting component 168 may drive the membrane 171 to change its shape by driving the first light-transmitting fluid 175 in the chamber 173 to flow, so that the surface 169 may be attached to the first lens 183.

In some embodiments, the light-transmitting component 168 includes a frame 185 and a second lens 189. The frame 185 has a first end 186 and a second end 187. The first lens 183 is located at the first end 186 of the frame 185. The second lens 189 closes the second end 187 of the frame 185. The membrane 171 is located between the first end 186 and the second end 187 and, together with the second end 187, forms the chamber 173 that may accommodate the light-transmitting fluid 175.

In some embodiments, the light-transmitting component 168 includes a driving module 201 to drive the first light-transmitting fluid 175 to flow. The driving module 201 may be provided in the chamber 173. In some embodiments, the original state of the light path switcher 16 is that the surface 169 of the membrane 171 is not attached to the first lens 183, and the second light-transmitting medium 163 is located between the membrane 171 and the first lens 183. In response to that the driving module 201 is started, the driving module 201 in the chamber 173 pushes the first light-transmitting fluid 175 to flow, so that the surface 169 of the membrane 171 is deformed towards the first lens 183 until the membrane 171 is attached to the first lens 183.

In response to that the driving module 201 stops driving, the driving module 201 stops pushing the first light-transmitting fluid 175, and the membrane 171 is restored to its original shape, so that the surface 169 is separated from the first lens 183 by the second light-transmitting medium 163 again.

In some embodiments, the surface 169 of the membrane 171 attached to the first lens 183, and the second light-transmitting medium 163 firstly accommodated in the accommodating space 165 may also be the original state of the light path switcher 16. In response to that the driving module 201 is started, the driving module 201 draws the first light-transmitting fluid 175 in the chamber 173 so that the first light-transmitting fluid 175 flows, so that the shape of the surface 169 of the membrane 171 is restored, and then the surface 169 is not attached to the first lens 183. At this time, the second light-transmitting medium 163 is shifted from the accommodating space 165 to a position between the surface 169 and the first lens 183.

In an embodiment where the first light-transmitting fluid 175 is driven to alter the surface 169 of the membrane 171, the driving module 201 may be implemented with a pump.

In some other embodiments where the surface 169 of the membrane 171 attached to the first lens 183 is the original state of the light path switcher 16, the driving module 201 may also be located in the accommodating space 165, the first light-transmitting fluid 175 is a compressible liquid, and when the driving module 201 is started, the driving module 201 drives the second light-transmitting medium 163 to shift from the accommodating space 165 to a position between the first lens 183 and the light-transmitting component 168. The space of the chamber 173 of the light-transmitting component 168 is compressed by the second light-transmitting medium 163, so that the surface 169 of the membrane 171 is not attached to the first lens 183.

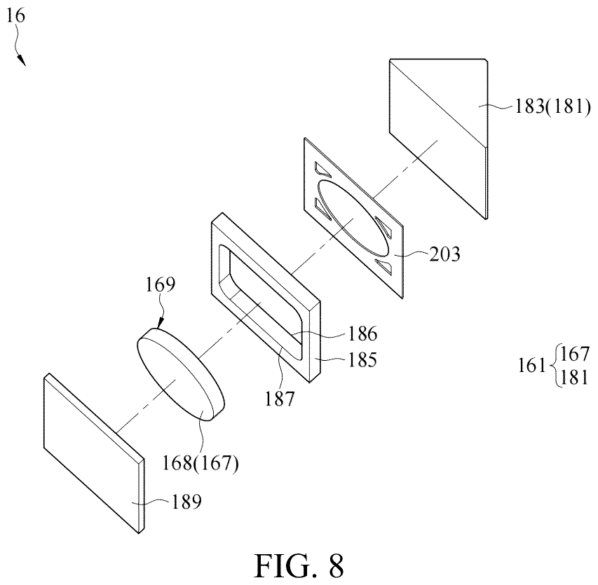

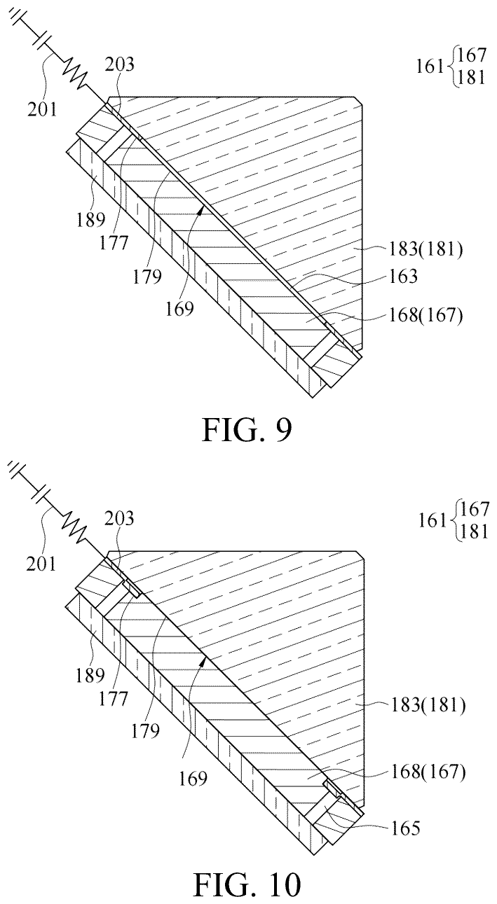

Refer to FIG. 8 to FIG. 10. FIG. 8 is a 3D exploded view of a light path switcher according to another embodiment, FIG. 9 is a sectional view of a light path switcher according to the embodiment of FIG. 8, showing that a first side and a second side are not attached to each other, and FIG. 10 is a sectional view of a light path switcher according to the embodiment of FIG. 8, showing that a first side and a second side are attached to each other. In some embodiments, the light path switcher 16 includes an actuator 203. The actuator 203 is located between the first lens 183 and the light-transmitting component 168. In this embodiment, the driving module 201 may be a circuit externally connected to the actuator 203, and the surface 169 of the light-transmitting component 168 includes an outer side 177 and an attaching portion 179. The driving module 201 generates a voltage to drive the actuator 203 to abut against the outer side 177 of the surface 169, so that the first light-transmitting fluid 175 in the membrane 171 flows to deform the attaching portion 179 so that the attaching portion 179 is attached to the first lens 183.

In some other embodiments, the driving module 201 makes the actuator 203 abut against the outer side 177 of the surface 169 by changing the voltage applied to the actuator 203, so that the first light-transmitting fluid 175 in the membrane 171 flows, deforming the attaching portion 179 so that the attaching portion 179 is attached to the first lens 183.

In the embodiment where the light path switcher 16 includes the actuator 203, the actuator 203 may also be magnetic, the driving module 201 may be an external coil or magnet and generate a magnetic force to drive the actuator 203 to abut against the outer side 177.

In some embodiments, the first light-transmitting fluid 175 may be a magnetic liquid metal. In response to that the driving module 201 generates magnetism, the liquid metal may be controlled to flow in the chamber 173 to change the shape of the surface 169 of the membrane 171, so that the surface 169 is attached to the first lens 183.

In the various embodiments above, the first light-transmitting fluid 175 is not limited to liquid metal, gel, liquid, gas and other fluids.

In some embodiments, the membrane 171 is implemented as a piezo micro electromechanical systems film. In this embodiment, the driving module 201 is an external circuit electrically connected to the membrane 171. In response to that the driving module 201 applies a voltage to the membrane 171 or changes the voltage applied to the membrane 171, the membrane 171 may change its shape to be or not to be attached to the first lens 183 without another actuator 203 abutting against the membrane 171.

In some embodiments, the light-transmitting component 168 may be of a solid fixed structure and have a surface 169. The surface 169 includes an outer side 177 and an attaching portion 179 located in the outer side 177. The driving module 201 drives the actuator 203 to abut against the outer side 177. Since the overall volume of the light-transmitting component 168 remains unchanged, in response to that the actuator 203 shifts in the direction away from the first lens 183 to abut against the outer side 177 of the light-transmitting component 168, the attaching portion 179 of the surface 169 of the light-transmitting component 168 shifts in the direction towards the first lens 183 to be attached to the first lens 183 (as shown in FIG. 10). In response to that the attaching portion 179 shifts in the direction towards the first lens 183, the second light-transmitting medium 163 originally located between the light-transmitting component 168 and the first lens 183 is pushed by the attaching portion 179 and is thus shifted to the accommodating space 165.

In some embodiments, in response to that the driving module 201 drives the actuator 203, the actuator 203 may be driven to change its shape to abut against the outer side 177 of the surface 169 in the light-transmitting component 168, or the entire actuator 203 may be driven to shift in a direction towards the light-transmitting component 168 to abut against the light-transmitting component 168.

In the foregoing embodiment, the attaching portion 179 and the first lens 183 not attached to each other is the original state of the light path switcher 16, and the attaching portion 179 is attached to the first lens 183 in response to that the actuator 203 is driven, but in some embodiments, the attaching portion 179 and the first lens 183 maintained attached to each other may also be the original state of the light path switcher 16. In this state, the actuator 203 continues to abut against the outer side 177 so that the attaching portion 179 and the first lens 183 continue to be attached to each other. In response to that the light path switcher 16 does not allow the imaging light IL to pass, the driving module 201 drives the actuator 203 to stay away from the light-transmitting component 168 so that the actuator 203 no longer abut against the outer side 177. At this time, the attaching portion 179 is not attached to the first lens 183, and the second light-transmitting medium 163 is shifted from the accommodating space 165 to a position between the light-transmitting component 168 and the first lens 183, so that the imaging light IL incident on the light path switcher 16 satisfies the condition of entering the optically thinner medium from the optically denser medium and is thus reflected at the light path switcher 16.

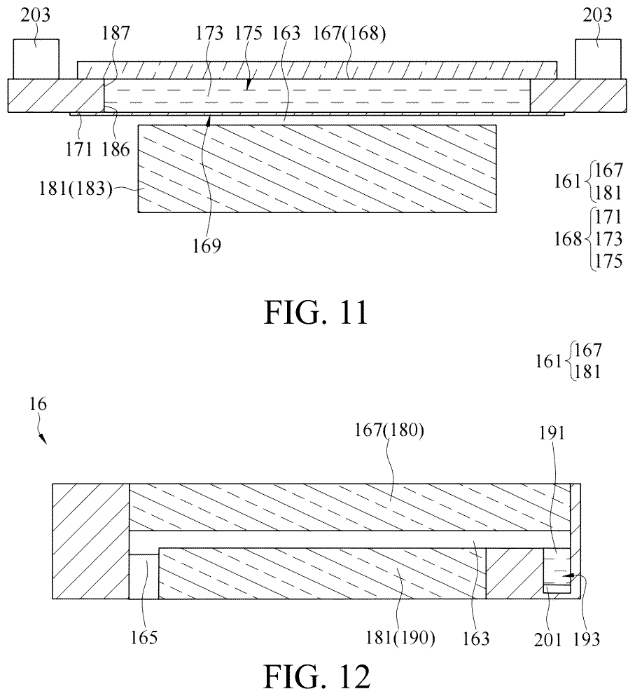

Refer to FIG. 11. FIG. 11 is a schematic diagram of a light path switcher according to yet another embodiment. In some embodiments, the driving module 201 is connected to the light-transmitting component 168 to drive the light-transmitting component 168 to shift in a direction towards the first lens 183, so that the surface 169 of the light-transmitting component 168 is attached to the first lens 183. For example, in an embodiment where the light-transmitting component 168 includes a frame 185, the driving module 201 may be located at the second end 187 of the frame 185 of the light-transmitting component 168 to push the frame 185 towards the first lens 183 until the surface 169 is attached to the first lens 183. The second light-transmitting medium 163 located between the light-transmitting component 168 and the first lens 183 is gradually accommodated in the accommodating space 165 during the period when the light-transmitting component 168 is shifted towards the first lens 183 to be attached to the first lens 183. Meanwhile, the second light-transmitting medium 163 in the accommodating space 165 gradually fills the region between the light-transmitting component 168 and the first lens 183 during the period when the light-transmitting component 168 is shifted away from the first lens 183 to be not attached to the first lens 183.

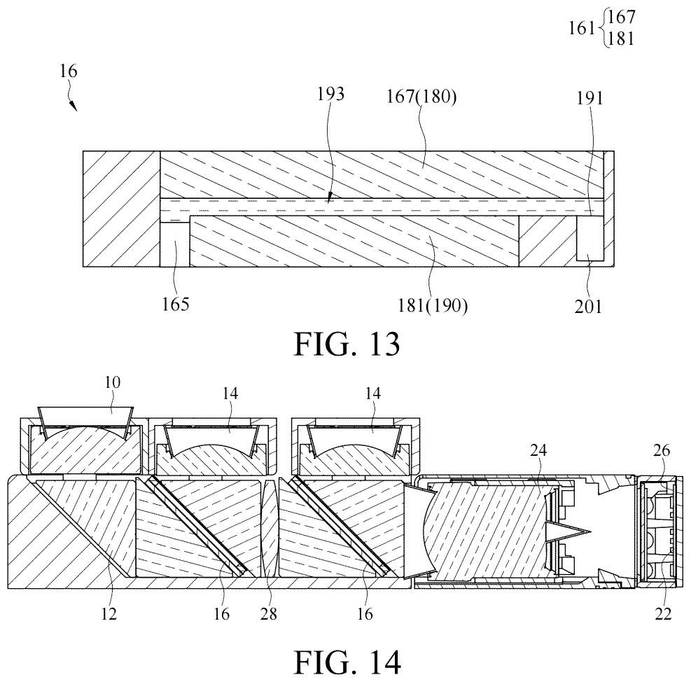

Refer to FIG. 12 and FIG. 13. FIG. 12 is a sectional view of a light path switcher according to an embodiment, showing that a second light-transmitting medium is located between a first side and a second side, and FIG. 13 is a sectional view of a light path switcher according to an embodiment, showing that a second light-transmitting medium is not located between a first side and a second side. In some embodiments, the light path switcher 16 includes a storage space 191 and a second light-transmitting fluid 193. The second light-transmitting fluid 193 is accommodated in the storage space 191. The second light-transmitting fluid 193 may be shifted from the storage space 191 to a position between the first side 167 and the second side 181.

In this embodiment, the first side 167 of the first light-transmitting medium 161 may be a third lens 180, the second side 181 may be a fourth lens 190, and the second light-transmitting fluid 193 has a fluid refractive index. The fluid refractive index may be greater than or equal to the first refractive index of the third lens 180 and/or the fourth lens 190. In response to that the second light-transmitting fluid 193 is accommodated in the storage space 191, the second light-transmitting medium 163 is located between the third lens 180 and the fourth lens 190 of the first light-transmitting medium 161. At this time, after the imaging light IL incident on the light path switcher 16 is incident on the second light-transmitting medium 163 via the third lens 180 and the fourth lens 190. Next, since the second refractive index of the second light-transmitting medium 163 less than the first refractive index meets the above-mentioned condition that the imaging light IL is incident on the optically thinner medium from the optically denser medium, the imaging light IL is totally reflected.

As mentioned above, the second light-transmitting fluid 193 may be shifted from the storage space 191 to a position between the third lens 180 and the fourth lens 190. In response to that the second light-transmitting fluid 193 is located between the third lens 180 and the fourth lens 190, the second light-transmitting medium 163 originally located between the third lens 180 and the fourth lens 190 is not located between the first side 167 and the second side 181 due to being squeezed by the second light-transmitting fluid 193. At this time, after the imaging light IL incident on the light path switcher 16 is incident on the second light-transmitting fluid 193 via the first side 167 or the second side 181, the imaging light IL passes through the second light-transmitting fluid 193.

In some embodiments, the second light-transmitting medium 163 may be air or vacuum located between the third lens 180 and the fourth lens 190. In response to that the second light-transmitting fluid 193 is shifted to a position between the third lens 180 and the fourth lens 190, if the second light-transmitting medium 163 is air, the air between the third lens 180 and the fourth lens 190 is pushed by the second light-transmitting fluid 193 to be accommodated in the accommodating space 165 communicated between the first side 167 and the second side 181 of the first light-transmitting medium 161; if the second light-transmitting medium 163 is vacuum, the vacuum is filled with the second light-transmitting fluid 193 with a refractive index greater than or equal to the first refractive index of the first side 167.

In this embodiment, the driving module 201 provided in the storage space 191, and the second light-transmitting fluid 193 located in the storage space 191 may be the original state of the light path switcher 16. In the original state, the driving module 201 does not perform driving, and the imaging light IL entering the image capture device is reflected at the light path switcher 16. In response to that the driving module 201 performs driving, the driving module 201 may drive the second light-transmitting fluid 193 to shift to a position between the third lens 180 and the fourth lens 190, so that the imaging light IL penetrates through the light path switcher 16.

On the contrary, in some other embodiments, the second light-transmitting fluid 193 located between the third lens 180 and the fourth lens 190 may also be the original state. In response to that the driving module 201 performs driving, the driving module 201 makes the second light-transmitting fluid 193 leave the position between the third lens 180 and the fourth lens 190 by drawing or the like so that the second light-transmitting fluid 193 is accommodated in the storage space 191. At this time, the second light-transmitting medium 163 is between the third lens 180 and the fourth lens 190, so that the imaging light IL is reflected at the light path switcher 16.

In some embodiments, the first lens 183, the second lens 189, the third lens 180, and the fourth lens 190 may be optical components available for the imaging light IL to penetrate, such as prisms or plane mirrors.

Refer to FIG. 2 and FIG. 4 again. In some embodiments, the first lens assembly 10 includes a first switch 101, and the second lens assembly 14 includes a second switch 141. The first switch 101 and the second switch 141 may be turned on or off to allow or not allow the imaging light IL to enter the first lens assembly 10 or the second lens assembly 14. In response to that the first side 167 and the second side 181 of the first light-transmitting medium 161 of the light path switcher 16 are attached to each other, the imaging light IL entering the image capture device from the first lens assembly 10 and the second lens assembly 14 passes through the light path switcher 16. The imaging light IL entering from the first lens assembly 10 will arrive at the image sensor 22 after passing through the light path switcher 16. At this time, the second switch 141 of the second lens assembly 14 can be turned off, so as to stop the imaging light IL from entering the image capture device from the second lens assembly 14. Thus, only the imaging light IL entering from one of the lens assemblies is retained in the image capture device, thereby preventing stray light in the image capture device from influencing the effect of an image captured by the image sensor 22.

In some embodiments, the first switch 101 may be located between the optical steering element 12 and the light path switcher 16, which is not limited here. The first switch 101 and the second switch 141 merely need to be provided upstream of the first lens assembly 10 and the second lens assembly 14 in relation to the light path along which the imaging light IL arrives at the light path switcher 16.

Refer to FIG. 2 and FIG. 3 again. Similarly, in response to that the first side 167 and the second side 181 of the first light-transmitting medium 161 of the light path switcher 16 are not attached to each other, the imaging light IL entering the image capture device from the first lens assembly 10 and the second lens assembly 14 is reflected at the light path switcher 16. The imaging light IL entering from the second lens assembly 14 will arrive at the image sensor 22 after being reflected at the light path switcher 16. At this time, the first switch 101 of the first lens assembly 10 may be turned off to stop the imaging light IL from entering the image capture device from the first lens assembly 10.

Refer to FIG. 2 again. In some embodiments, the first lens assembly 10 includes a first lens group 103. The first lens group 103 is located between the optical steering element 12 and the first switch 101. In an embodiment where the optical steering element 12 includes an incident surface 123, the first lens group 103 is located between the incident surface 123 and the first switch 101. The second lens assembly 14 includes a second lens group 143 adjacent to the second switch 141. The first optical axis OA1 of the first lens assembly 10 is the optical axis of the first lens group 103. The second optical axis OA2 of the second lens assembly 14 is the optical axis of the second lens group 143.

The first lens group 103 and the second lens group 143 may have different focal lengths, so that the image capture device has light paths for different magnifications. In response to that the user uses the image capture device to capture images of an object or scene, they can choose to use the first lens assembly 10 or the second lens assembly 14 for shooting in accordance with the magnification requirements for shooting. In response to that the user chooses the first lens assembly 10, the first switch 101 of the first lens assembly 10 is turned on, and the second switch 141 of the second lens assembly 14 is turned off. Therefore, the light path switcher 16 allows the imaging light IL entering from the first lens assembly 10 to pass, and the image sensor 22 receives the imaging light IL entering from the first lens assembly 10.

In response to that the user chooses the second lens assembly 14, the first switch 101 of the first lens assembly 10 is turned off, and the second switch 141 of the second lens assembly 14 is turned on. The imaging light IL entering from the second lens assembly 14 is reflected at the light path switcher 16, and the image sensor 22 receives the imaging light IL entering from the second lens assembly 14.

Since the first lens assembly 10 and the second lens assembly 14 are switched by the light path switcher 16 to allow the imaging light IL on different light paths to arrive at the image sensor 22, changes in the positions of various optical components (e.g., the optical steering element 12, the first lens group 103, the second lens group 143) in the image capture device on the light path are reduced, and the influence on the quality of the image captured by the image sensor 22 is reduced.

Refer to FIG. 2 further. In some embodiments, the optical steering element 12 further includes an incident surface 123 and an exit surface 125. The first optical axis OA1 of the first lens assembly 10 is incident from the incident surface 123 and exits from the exit surface 125 after being reflected at the reflecting surface 121. In some embodiments, the image sensor 22 has a sensing optical axis OA3. In response to that the first side 167 and the second side 181 of the first light-transmitting medium 161 are not attached to each other, light along the first optical axis OA1 exiting from the exit surface 125 cannot penetrate through the first side 167 and the second side 181, and the second optical axis OA2 reflected at the light path switcher 16 are aligned with the sensing optical axis OA3.

In some embodiments, the optical steering element 12 may be a prism, or any component that may reflect the imaging light IL may serve as the reflecting surface 121, and components that may allow the imaging light IL to penetrate serve as the incident surface 123 and the exit surface 125, thereby changing the transmission direction of the imaging light IL incident on the first lens assembly 10.

In some embodiments, the light path switcher 16 may be attached to the exit surface 125 of the optical steering element 12 using one of the first lens 183 and the second lens 189, and the light path switcher 16 may be attached to the second lens assembly 14 using the other of the first lens 183 and the second lens 189, so as to prevent an air gap on the light path along which the imaging light IL travels and thereby prevent an additional phenomenon of a light entering an optically denser medium from an optically thinner medium (beside the imaging light IL entering the second light-transmitting medium 163 from the first light-transmitting medium 161).

In some embodiments, the image capture device further includes a focusing module 24. The focusing module 24 includes a focusing lens assembly 241 and an actuating device 243. The focusing module 24 is located between the light path switcher 16 and the image sensor 22, and the actuating device 243 may actuate the focusing module 24 to shift along the sensing optical axis OA3 to change the focal length of the image capture device. Therefore, in an embodiment where the first lens group 103 of the first lens assembly 10 and the second lens group 143 of the second lens assembly 14 have different focal lengths, the image capture device may have a larger focusing range.

For example, the first lens group 103 and the second lens group 143 each may be a general lens, a telephoto lens, a macro lens, a wide-angle lens, or the like. The interaction between the first lens group 103 and the variable-focal-length focusing lens assembly 241 may allow the image capture device to have a focal length range. For example, the shooting magnification of the image capture device may be between 0.5 times and 1 time. Meanwhile, the interaction between the second lens group 143 and the variable-focal-length focusing lens assembly 241 may allow the image capture device to have another focal length range. For example, the shooting magnification of the image capture device may be between 1 time and 3 times. Therefore, the shooting magnification of the image capture device may be between 0.5 times and 3 times.

Refer to FIG. 14. FIG. 14 is a sectional view of an image capture device according to yet another embodiment. In some embodiments, the number of the second lens assemblies 14 in the image capture device may be greater than one. For example, the number of the second lens assemblies 14 shown in FIG. 14 is 2, and all of the second lens assemblies 14 are adjacent to each other and may have different focal lengths. In response to that the number of the second lens assemblies 14 is greater than one, the number of the light path switchers 16 is also greater than one and corresponds to the number of the second lens assemblies 14. All of the light path switchers 16 are each located downstream of the optical steering element 12 and one of the second lens assemblies 14 in relation to the light path.

In some embodiments, the image capture device includes a light-transmitting component 28. The light-transmitting component 28 may be located between the first lens assembly 10 and the second lens assembly 14, or the light-transmitting component 28 may be located between all of the second lens assemblies 14 in response to that the number of the second lens assemblies 14 is greater than one. The light-transmitting component 28 may be implemented as an optical filter, various lenses or apertures, etc.

In some embodiments, the image capture device includes a stabilization module 26. The stabilization module 26 is electrically connected to the image sensor 22. In response to that vibration such as hand tremor is generated when the image capture device is in use, the stabilization module 26 may drive the image sensor 22 to generate movement corresponding to the hand tremor to offset the hand tremor.

To sum up, the image capture device with multiple lens assemblies can switch its light paths through the light path switcher, so that the image capture device can ensure the quality of a shot image while shooting in different focal length ranges.

What is claimed is:

1. An image capture device, comprising:
a first lens assembly, having a first optical axis;
an optical steering element, adjacent to the first lens assembly and comprising a reflecting surface, wherein the first optical axis is reflected at the reflecting surface;
a second lens assembly, adjacent to the first lens assembly and having a second optical axis, wherein the second optical axis is parallel to the first optical axis;
a light path switcher, located downstream of the reflecting surface and the second lens assembly in relation to a light path, wherein the light path switcher is configured to selectively allow or not allow imaging light entering from the first lens assembly and the second lens assembly to pass, and the light path switcher comprises:
a first light-transmitting medium, wherein the imaging light is configured to be incident on the first light-transmitting medium at an angle of incidence, the angle of incidence is greater than or equal to a critical angle, the first light-transmitting medium comprises a first side and a second side opposite to each other, and the first side has a first refractive index; and
a second light-transmitting medium, located between the first side and the second side of the first light-transmitting medium and having a second refractive index, wherein the second refractive index is less than the first refractive index;
wherein in response to that the second light-transmitting medium is located between the first side and the second side, the light path switcher is configured to allow the imaging light incident on the first light-transmitting medium to be reflected at the first light-transmitting medium;
in response to that the second light-transmitting medium is not located between the first side and the second side, the light path switcher is configured to allow the imaging light incident on the first light-transmitting medium to pass through the first light-transmitting medium; and
an image sensor, located downstream of the light path switcher in relation to the light path and configured to capture the imaging light.

2. The image capture device according to claim 1, wherein the second side of the first light-transmitting medium is a first lens, the first side of the first light-transmitting medium is a light-transmitting component, the light-transmitting component has a surface, and the light-transmitting component is attached or not attached to the first lens with the surface.

3. The image capture device according to claim 2, wherein the light path switcher comprises an accommodating space, the accommodating space is communicated between the first side and the second side of the first light-transmitting medium, and in response to that the light-transmitting component is attached to the first lens with the surface, the second light-transmitting medium is accommodated in the accommodating space.

4. The image capture device according to claim 2, wherein the light-transmitting component comprises a membrane and a first light-transmitting fluid, the membrane forms a chamber, the first light-transmitting fluid is accommodated in the chamber, and the surface is a side of the membrane facing the first lens.

5. The image capture device according to claim 4, wherein the light-transmitting component further comprises a frame and a second lens, the frame has a first end and a second end, the first lens is located at the first end of the frame, and the second lens closes the second end of the frame to form the chamber with the membrane.

6. The image capture device according to claim 4, wherein the light path switcher further comprises a driving module configured to drive the first light-transmitting fluid to flow so as to deform the membrane so that the membrane is attached to the first lens.

7. The image capture device according to claim 4, wherein the light path switcher further comprises a driving module, and the driving module is configured to drive the first light-transmitting fluid to flow so as to deform the membrane so that the membrane is separated from the first lens.

8. The image capture device according to claim 4, wherein the light path switcher further comprises a driving module and an actuator, the surface comprises an outer side and an attaching portion located in the outer side, and the driving module is configured to drive the actuator to abut against the outer side so as to make the first light-transmitting fluid flow to deform the attaching portion so that the attaching portion is attached to the first lens.

9. The image capture device according to claim 8, wherein the driving module is configured to generate a voltage to drive the actuator to abut against the membrane.

10. The image capture device according to claim 8, wherein the actuator is magnetic, and the driving module generates a magnetic force to make the actuator abut against the membrane.

11. The image capture device according to claim 2, wherein the light path switcher further comprises a driving module and an actuator, the surface comprises an outer side and an attaching portion located in the outer side, and the driving module is configured to drive the actuator to abut against the outer side so as to make the outer side shift in a direction away from the first lens, so that the attaching portion shifts in a direction towards the first lens to be attached to the first lens.

12. The image capture device according to claim 2, wherein the light path switcher further comprises a driving module, and the driving module is configured to drive the light-transmitting component to shift towards the first lens, so that the light-transmitting component is attached to the first lens.

13. The image capture device according to claim 1, wherein the light path switcher comprises a storage space and a second light-transmitting fluid, the storage space is communicated between the first side and the second side of the first light-transmitting medium, in response to that the second light-transmitting medium is located between the first side and the second side, the second light-transmitting fluid is accommodated in the storage space, and in response to that the second light-transmitting medium is not located between the first side and the second side, the second light-transmitting fluid is configured to shift from the storage space to a position between the first side and the second side.

14. The image capture device according to claim 13, wherein the second light-transmitting fluid has a fluid refractive index, and the fluid refractive index is greater than or equal to the first refractive index.

15. The image capture device according to claim 1, wherein the second light-transmitting medium is air, and the refractive index of the first light-transmitting medium is greater than the refractive index of the air.

16. The image capture device according to claim 1, wherein the optical steering element further comprises an incident surface and an exit surface, and the first optical axis is incident from the incident surface and exits from the exit surface after being reflected at the reflecting surface.

17. The image capture device according to claim 1, wherein the first lens assembly comprises a first switch, and the second lens assembly comprises a second switch; in response to that the first side and the second side of the first light-transmitting medium of the light path switcher are attached to each other, the first switch is configured to be turned on to allow the imaging light to pass, and in response to that the first side and the second side of the first light-transmitting medium of the light path switcher are not attached to each other, the second switch is configured to be turned on to allow the imaging light to pass.

18. The image capture device according to claim 17, wherein the first lens assembly comprises a first lens group, the first lens group is located between the optical steering element and the first switch, and the second lens assembly comprises a second lens group adjacent to the second switch.

19. The image capture device according to claim 1, wherein the image sensor has a sensing optical axis, and the sensing optical axis is aligned with the first optical axis of the first lens assembly reflected at the reflecting surface and is aligned with the second optical axis reflected at the light path switcher in response to that the first side and the second side of the first light-transmitting medium are not attached to each other.

20. The image capture device according to claim 19, further comprising a focusing module, wherein the focusing module comprises a focusing lens assembly and an actuating device, the focusing module is located between the light path switcher and the image sensor, and the actuating device is configured to actuate the focusing lens assembly to shift along the sensing optical axis.

21. The image capture device according to claim 1, further comprising a stabilization module electrically connected to the image sensor, wherein the stabilization module is configured to drive the image sensor to generate corresponding movement to offset hand tremor.

22. The image capture device according to claim 1, wherein the first lens assembly and the second lens assembly each have a focal length, and the focal lengths of the first lens assembly and the second lens assembly are different.

23. The image capture device according to claim 1, wherein a number of the second lens assemblies is greater than one, a number of the light path switchers is greater than one, all of the second lens assemblies are adjacent to each other, and all of the light path switchers are each located downstream of one of the second lens assemblies and the reflecting surface of the optical steering element in relation to the light path.

24. The image capture device according to claim 23, further comprising a light-transmitting component located between the first lens assembly and the second lens assemblies.

25. The image capture device according to claim 23, further comprising a light-transmitting component located between each of the second lens assemblies.

26. A light path switcher, comprising:
a first light-transmitting medium, wherein imaging light is configured to be incident on the first light-transmitting medium at an angle of incidence, the angle of incidence is greater than or equal to a critical angle, the first light-transmitting medium comprises a first side and a second side opposite to each other, and the first side has a first refractive index; and
a second light-transmitting medium, located between the first side and the second side of the first light-transmitting medium and having a second refractive index, wherein the second refractive index is less than the first refractive index;
wherein in response to that the second light-transmitting medium is located between the first side and the second side, the light path switcher is configured to allow the imaging light incident on the first light-transmitting medium to be reflected at the first light-transmitting medium; and
in response to that the second light-transmitting medium is not located between the first side and the second side, the light path switcher is configured to allow the imaging light incident on the first light-transmitting medium to pass through the first light-transmitting medium.
